(19) United States
(12) Patent Application Publication
(10) Pub. No.: US 2003/0236800 A1
(43) Pub. Date: Dec. 25, 2003

(54) Dynamic recovery system and method

(76) Inventors: Courtney D. Goeltzenleuchter, Fort Collins, CO (US); Kenneth Scott Bower, Fort Collins, CO (US); Jeffrey Joel Walls, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/174,639

(22) Filed: Jun. 19, 2002

(51) Int. Cl. G06F 12/00

(52) U.S. Cl. 707/204

(57) ABSTRACT

A dynamic recovery system comprises a plurality of render nodes each adapted to render data received from a master node. Each of the render nodes is further adapted to receive a render command from the master node indicating a portion of the data to be rendered by the corresponding render node. The system also comprises a control application coupled to each of the render nodes and adapted to automatically reallocate the portion of the data rendered by at least one of the render nodes among a remaining portion of the render nodes in response to an event corresponding to the at least one render node.

### TECHNICAL FIELD OF THE INVENTION

The present invention relates generally to the field of data communications and, more particularly, to a dynamic recovery system and method.

### BACKGROUND OF THE INVENTION

Clustered computer systems generally comprise a plurality of discrete computer systems working together to perform a generally common function or to achieve a related end result. For example, each discrete computer system may perform a particular function which may be combined with results from other computer systems to obtain a particular end result. However, system failure in clustered computer systems may often prevent the clustered system from efficiently operating. For example, if the likelihood that a single computer within the clustered system will fail on any given day is about one percent, a clustered system with fifty computers will have a failure probability of approximately forty percent. Thus, although clustered computer systems may be used more expediently to resolve various tasks, the risk of system failure may be prohibitively high, especially as the quantity of discrete computers of the clustered system increases.

### SUMMARY OF THE INVENTION

In accordance with one embodiment of the present invention, a dynamic recovery system comprises a plurality of render nodes each adapted to render data received from a master node. Each of the render nodes is further adapted to receive a render command from the master node indicating a portion of the data to be rendered by the corresponding render node. The system also comprises a control application coupled to each of the render nodes and adapted to automatically reallocate the portion of the data rendered by at least one of the render nodes among a remaining portion of the render nodes in response to an event corresponding to the at least one render node.

In accordance with another embodiment of the present invention, a method for dynamic recovery comprises transmitting data to each of a plurality of render nodes and transmitting a render command to each of the render nodes indicating a portion of the data to be rendered by the corresponding render node. The method also comprises automatically reallocating the portion of the data rendered by at least one of the render nodes among a remaining portion of the render nodes in response to an event corresponding to the at least one of the render nodes.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of a dynamic recovery system in accordance with the present invention;

FIG. 2 is a diagram illustrating an embodiment of a dynamic recovery system in accordance with the present invention; and

FIG. 3 is a flow chart illustrating an embodiment of a method for dynamic recovery in accordance with the present invention.

### DETAILED DESCRIPTION OF THE DRAWINGS

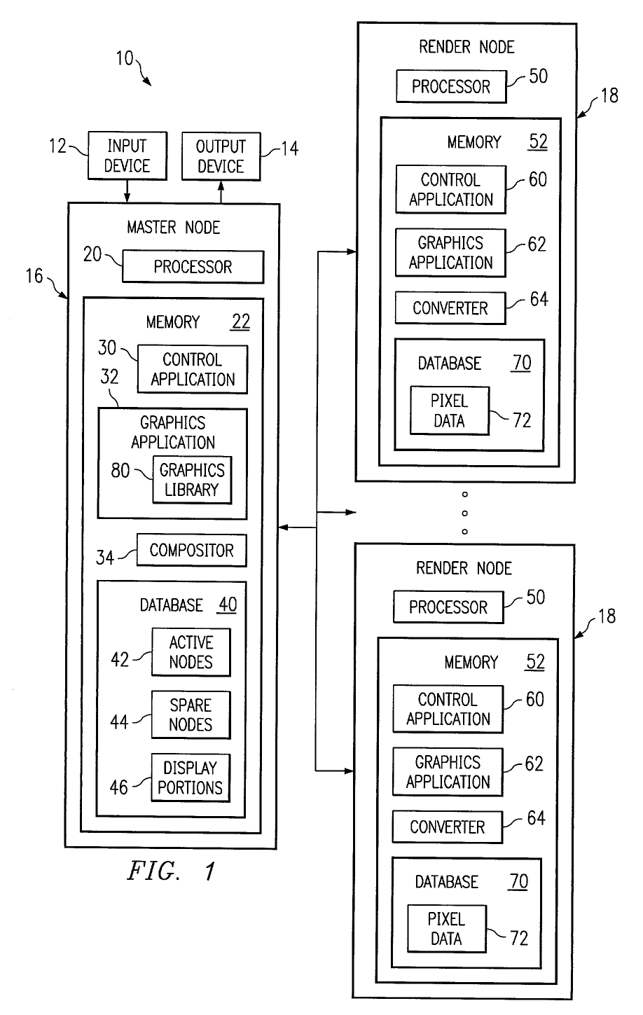

The preferred embodiments of the present invention and the advantages thereof are best understood by referring to FIGS. 1-3 of the drawings, like numerals being used for like and corresponding parts of the various drawings.

FIG. 1 is a diagram illustrating an embodiment of a dynamic recovery system 10 in accordance with the present invention. Briefly, system 10 provides dynamic recovery from events such as a disconnection or system malfunction without requiring redundant hardware and/or software. For example, in accordance with an embodiment of the present invention, data is transmitted to each of a plurality of nodes for processing. Each node is responsible for rendering a portion of the data. The rendered data from each node is then combined to form a complete or overall data construction. If an event, such as a disconnection or system failure, is detected corresponding to any of the nodes, the rendered portions may be reallocated such that data corresponding to the defective or disconnected node is rendered by one or more of the remaining nodes. In the illustrated embodiment, system 10 is described in connection with generating graphical data and dynamic recovery in a clustered graphics environment; however, it should be understood that system 10 may be used in other applications, thereby providing real-time dynamic system recovery for a variety of applications.

In the illustrated embodiment, system 10 comprises an input device 12, an output device 14, a master node 16, and a plurality of render nodes 18. Input device 12 may comprise a keyboard, keypad, pointing device, such as a mouse or a track pad, a scanner, or other type of device for inputting information into master node 16. Output device 14 may comprise a monitor, display, printer, or other type of device for generating an output. In the embodiment of FIG. 1, master node 16 comprises a processor 20 and a memory 22. The present invention also encompasses computer software that may be executed by processor 20. In the illustrated embodiment, memory 22 comprises a control application 30, a graphics application 32, and a compositor 34, which are computer software programs. However, it should be understood that system 10 may be implemented using software, hardware, or a combination of software and hardware. In the embodiment of FIG. 1, control application 30, graphics application 32, and compositor 34 are illustrated as being stored in memory 22, where they may be executed by processor 20. However, control application 30, graphics application 32, and compositor 34 may be otherwise stored as to be accessible by processor 20.

In the illustrated embodiment, master node 16 also comprises a database 40 stored in memory 22. Database 40 comprises information associated with each of render nodes 18. For example, in the illustrated embodiment, database 40 comprises information associated with identifying particular render nodes 18 as active render nodes 42 or spare render nodes 44. Database 40 may also comprise information associated with each display portion 46 assigned to each render node 18. For example, each render node 18 may be assigned a particular portion of an overall display for data rendering.

Each render node 18 comprises a processor 50 and a memory 52. The present invention also encompasses computer software that may be executed by processor 50. In the illustrated embodiment, memory 52 comprises a control application 60, a graphics application 62, and a converter 64, which are computer software programs. However, it should be understood that control application 60, graphics application 62, and converter 64 may be implemented using hardware, software, or a combination of hardware and software. In the embodiment of FIG. 1, control application 60, graphics application 62, and converter 64 are illustrated as being stored in memory 52, where they may be executed by processor 50. However, control application 60, graphics application 62, and converter 64 may be otherwise stored so as to be accessible by processor 50. In the illustrated embodiment, each render node 18 also comprises a database 70 stored in memory 52. Database 70 comprises information associated with rendering data received from master node 16. For example, in the illustrated embodiment, database 70 comprises pixel data 72 associated with information generated by render node 18 in response to receiving data from master node 16.

Briefly, in operation, master node 16 transmits data to each render node 18 to accommodate rendering of the transmitted data by render nodes 18. System 10 may be configured such that each render node 18 renders a portion of the transmitted data or may be configured such that a portion of the available render nodes 18 renders the transmitted data. In the illustrated embodiment, graphics application 32 comprises a graphics library 80 for generating and transmitting graphics commands to each render node 18. The graphics commands may comprise various types of information and/or instructions relating to rendering of the data by each render node 18.

Control application 30 maintains a listing of each render node 18 in communication with graphics library 80 to determine available render nodes 18 for rendering the transmitted data. Control application 30 also assigns each render node a designated portion of the data for rendering such that the data is divided, equally or unequally, between a predetermined quantity of render nodes 18. Control application 30 may also designate a portion or set of one or more render nodes 18 as active render nodes 42 for rendering the transmitted data and a portion or set of one or more render nodes 18 as spare render nodes 44. Alternatively, control application 30 may designate each of render nodes 18 as active render nodes 42 such that each render node 18 renders a portion of the received data. Compositor 34 receives the rendered data from each render node 18 processing the data and combines the data relative to each other corresponding to the type of data. For example, in the illustrated embodiment, graphical data is rendered by each render node 18 such that the rendered portions of data may be combined by compositor 34 to generate an overall or complete display corresponding to the graphical data.

In accordance with an embodiment of the present invention, in response to detecting an event corresponding to at least one of render nodes 18, control application 30 may dynamically reallocate portions of the data to be rendered by the remaining render nodes 18. For example, as used throughout herein, an event may comprise a disconnection of render node 18 from master node 16, a failure associated with render node 18, or any other type of occurrence affecting transmittal, receipt, or rendering of data associated with one or more render nodes 18. Accordingly, in response to detecting an event corresponding to one or more render nodes 18, control application 30 may automatically reallocate rendering responsibility among a remaining quantity of render nodes 18. Additionally, if spare render nodes 44 were designated by control application 30, one or more spare render nodes 44 may be converted to active render nodes 42 to accommodate rendering of data as a substitute for the event-connected render node 18.

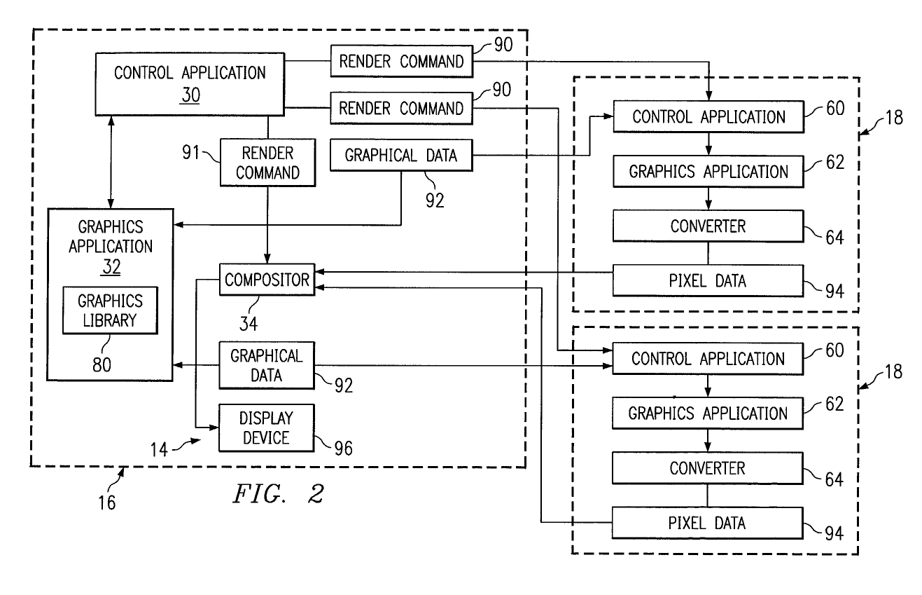

FIG. 2 is a diagram illustrating information transfer between master node 16 and render nodes 18 in accordance with an embodiment of the present invention. In operation, graphics library 80 initiates or attempts to initiate a connection with each render node 18 coupled to master node 16. After a connection is established to various render nodes 18, control application 30 determines an identity associated with each render node 18. As described above, a portion or set of one or more render nodes 18 may be designated as active render nodes 44 and/or spare render nodes 44. Alternatively, each connected render node 18 may be designated as an active render node 42 such that each render node 18 is responsible for rendering a portion of data received from master node 16.

Control application 30 then generates a render command 90 indicating the portion of data to be rendered by each corresponding render node 18. For example, in a graphical application, each render node 18 may be responsible for rendering a particular portion, such as a field or quadrant, of an overall graphical display such that each portion may be later combined by compositor 34 to obtain a complete or overall graphical display. Control application 30 transmits render command 90 to control application 60 of each render node 18 such that each corresponding render node 18 may render the designated portion of data. Control application 30 also generates and transmits a render command 91 to compositor 34 indicating the portion of data to be rendered by each designated render node 18 so that compositor 34 may correctly combine each of the rendered portions of data received from each corresponding render node 18.

As described above, graphics library 80 generates and transmits graphical commands to each render node 18. Each graphical command may comprise graphical data 92 and other instructions and/or information related to graphical data 92. Control application 60 of each render node 18 receives graphical data 92 and determines the portion of graphical data 92 to be rendered corresponding to render command 90. For example, render command 90 may indicate for each render node 18 a corresponding display portion of a complete or overall display of graphical data 92 such that each render node 18 renders the corresponding designated portion of graphical data 92. Accordingly, graphics application 62 renders the particular portion of graphical data 92 corresponding to render command 90. Converter 64 converts graphical information generated by graphics application 62 into pixel data 94 and transmits pixel data 94 to compositor 34.

Upon receipt of pixel data 94 from each render node 18, compositor 34 combines pixel data 94 relative to each other corresponding to render command 91 to generate a complete or overall graphical display using pixel data 94. Compositor 34 may then transmit the combined pixel data 94 to output device 14, such as a display device 96.

If control application 30 detects an event corresponding to one of render nodes 18, control application 30 may generate a new render command 90 reallocating the display portion rendered by each render node 18. For example, if one of render nodes 18 becomes disconnected from master node 16 or otherwise is unable to receive or render graphical data 92, control application 30 may dynamically reallocate the display portion to be rendered by the remaining render nodes 18, thereby increasing, decreasing, or otherwise modifying the display portion assigned to the remaining render nodes 18. Accordingly, control application 30 generates new render commands 90 and 91 and transmits the new render commands 90 and 91 to remaining render nodes 18 and compositor 34, respectively, such that display of the data on display device 96 may be substantially uninterrupted. Thus, in accordance with an embodiment of the present invention, data is transmitted to each of render nodes 18 so that rendering portions assigned to render nodes 18 may be automatically and dynamically modified while maintaining a substantially uninterrupted flow of data processing.

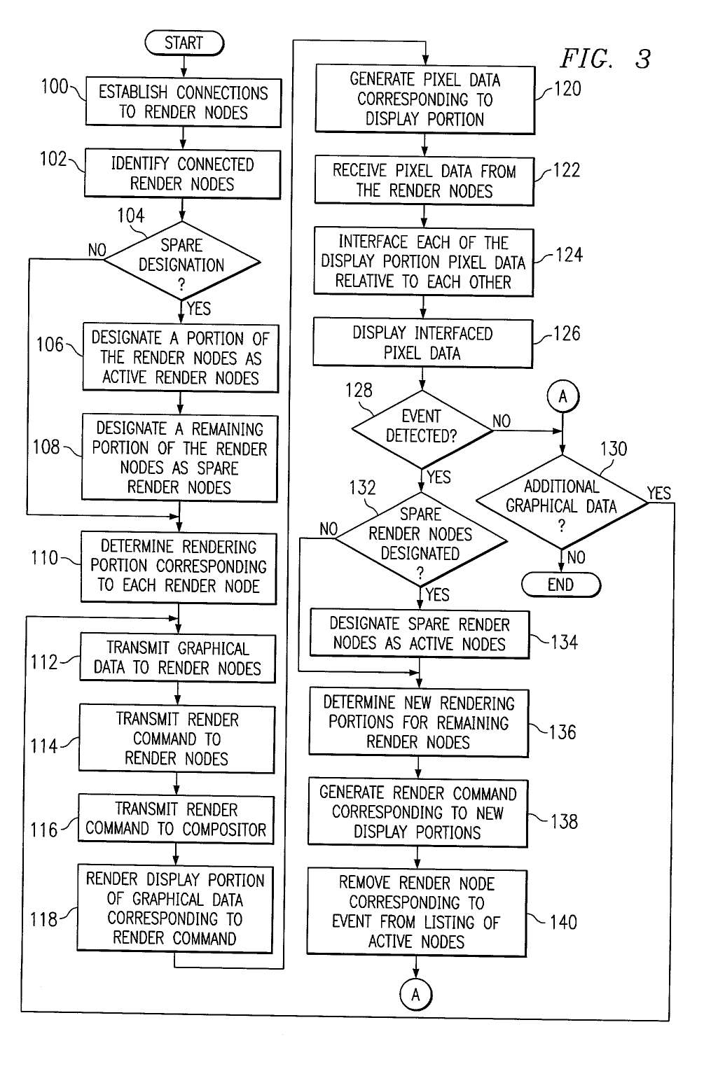

FIG. 3 is a flowchart illustrating a method for dynamic recovery in accordance with an embodiment of the present invention. The method begins at step 100, where master node 16 establishes a connection to render nodes 18. At step 102, control application 30 identifies each render node 18 connected to master node 16 for communicating information between master node 16 and render nodes 18. At decisional step 104, a determination is made whether one or more render nodes 18 shall be designated as spare render nodes 44. If a spare designation is requested, the method proceeds to step 106, where control application 30 designates a portion of render nodes 18 as active render nodes 42. At step 108, control application 30 designates a remaining portion of render nodes 18 as spare render nodes 44. If spare designation is not requested at decisional step 104, the method proceeds from step 104 to step 110.

At step 110, control application 30 determines a rendering portion corresponding to each render node 18. For example, as described above, each render node 18 may be responsible for rendering data associated with a particular portion, field, or quadrant of an overall display. At step 112, graphics application 32 transmits graphical data 92 to each render node 18. At step 114, control application 30 generates and transmits render command 90 to each render node 18. At step 116, control application 30 also transmits render command 91 to compositor 34.

At step 118, render nodes 18 render the portions of graphical data 92 corresponding to render command 90. At step 120, converter 64 of each render node 18 generates pixel data 94 corresponding to the portion identified by render command 90. At step 122, compositor 34 receives pixel data 94 from each of the render nodes 18. At step 124, compositor 34 combines each of the pixel data 94 received from render nodes 18 relative to each other to form a complete display corresponding to graphical data 92 corresponding to render command 91. At step 126, compositor 34 may display the combined pixel data 94 on display device 96.

At decisional step 128, control application 30 determines whether an event corresponding to one or more of render nodes 18 is detected. If control application 30 does not detect an event corresponding to one or more of render nodes 18, the method proceeds to decisional step 130, where control application 30 determines whether additional graphical data 92 require rendering by render nodes 18. If additional graphical data 92 require rendering by render nodes 18, the method returns to step 112. If no additional graphical data 92 require rendering by render nodes 18, the method ends.

At decisional step 128, if control application 30 detects an event corresponding to one or more of render nodes 18, the method proceeds to decisional step 132, where control application 30 determines whether spare render nodes 44 were designated. If spare render nodes 44 were designated by control application 30, the method proceeds to step 134, where control application 30 converts one or more spare render nodes 44 to active render nodes 42. If spare render nodes 44 were not designated, the method proceeds from step 132 to step 136.

At step 136, control application 30 determines new rendering portions for each of the remaining render nodes 18. At step 138, control application generates a new render command 90 corresponding to the reallocated rendering portions for the remaining render nodes 18. At step 140, the render node 18 corresponding to the event is removed from a listing of active render nodes 42. The method then proceeds to step 130.

It should be understood that in the described method, certain steps may be omitted, accomplished in a sequence different from that depicted in FIG. 3, or performed simultaneously. Also, it should be understood that the method depicted in FIG. 3 may be altered to encompass any of the other features or aspects of the invention as described elsewhere in the specification. For example, various steps of the method depicted in FIG. 3 may be repeated, either periodically or continuously, such as steps 100 through 108 to accommodate render nodes 18 being added, deleted, or otherwise modified or managed.

What is claimed is:

1. A dynamic recovery system, comprising:
a plurality of render nodes each adapted to render data received from a master node, each of the render nodes further adapted to receive a render command from the master node indicating a portion of the data to be rendered by the corresponding render node; and
a control application coupled to each of the render nodes and adapted to automatically reallocate the portion of the data rendered by at least one of the render nodes among a remaining portion of the render nodes in response to an event corresponding to the at least one render node.

2. The system of claim 1, wherein the master node is adapted to poll each of the render nodes to determine an operating status corresponding to each of the render nodes.

3. The system of claim 1, wherein the control application is adapted to designate at least one of the plurality of render nodes as a spare render node.

4. The system of claim 3, wherein the control application is adapted to reallocate to the spare render node the portion of the data rendered by the at least one render node corresponding to the event.

5. The system of claim 1, wherein the plurality of render nodes comprises:
a plurality of active render nodes; and
at least one spare render node.

6. The system of claim 1, wherein the master node is further adapted to transmit the render command to a compositor.

7. The system of claim 1, wherein each render node comprises a converter adapted to generate pixel data.

8. The system of claim 1, wherein the master node is adapted to establish a communication connection to each of the render nodes.

9. The system of claim 1, further comprising a compositor adapted to combine each of the rendered portions of the data relative to each other.

10. The system of claim 1, wherein the event comprises a failure corresponding to one of the render nodes.

11. A method for dynamic recovery, comprising:
transmitting data to each of a plurality of render nodes;
transmitting a render command to each of the render nodes indicating a portion of the data to be rendered by the corresponding render node; and
automatically reallocating the portion of the data rendered by at least one of the render nodes among a remaining portion of the render nodes in response to an event corresponding to the at least one of the render nodes.

12. The method of claim 11, further comprising designating at least one of the plurality of render nodes as a spare render node.

13. The method of claim 11, further comprising automatically updating each render node in response to the reallocation.

14. The method of claim 11, further comprising determining a quantity of available render nodes.

15. The method of claim 14, further comprising transmitting the render command to a compositor.

16. The method of claim 11, wherein reallocating comprises reallocating the portion in response to a failure corresponding to one of the render nodes.

17. The method of claim 11, further comprising combining each of the rendered portions of the data relative to each other.

18. A dynamic recovery system, comprising:
a graphics application adapted to receive graphical data from a master node;
a converter adapted to generate pixel data from the graphical data corresponding to a predetermined display portion; and
a control application adapted to receive a render command modifying the predetermined display portion.

19. The system of claim 18, wherein the control application is adapted to transmit an identification command to the master node.

20. The system of claim 18, wherein the control application is adapted to receive the render command increasing the predetermined display portion.

21. The system of claim 18, wherein the control application is adapted to receive the render command decreasing the predetermined display portion.

22. The system of claim 18, wherein the converter is adapted to transmit the pixel data to the master node.

23. A dynamic recovery system, comprising:
means for transmitting data to each of a plurality of render nodes;
means for transmitting a render command to each of the render nodes, the render command indicating a portion of the data to be rendered by a corresponding render node; and
means for reallocating a portion of the data rendered by at least one of the render nodes among a remaining portion of the render nodes in response to an event corresponding to the at least one render node.

24. The system of claim 23, further comprising means for designating at least one of the plurality of render nodes as a spare render node.

25. The system of claim 23, wherein the means for reallocating comprises means for automatically reallocating the portion of the data.

26. The system of claim 25, further comprising means for combining the rendered data relative to each other.

27. The system of claim 23, further comprising means for transmitting the render command to a compositor.

28. The system of claim 23, further comprising means for establishing a connection to each of the render nodes.

29. The system of claim 23, further comprising means for determining which of the render nodes comprise active render nodes.

30. A dynamic recovery system, comprising:
a graphics application adapted to transmit graphical data to each of a plurality or render nodes; and
a control application adapted to reallocate a display portion assigned to at least one of the render nodes in response to an event corresponding to the at least one of the render nodes.

31. The system of claim 30, wherein the graphics application is further adapted to establish a connection to the render nodes.

32. The system of claim 30, wherein the control application is adapted to designate at least one of the plurality of render nodes as a spare render node.

33. The system of claim 30, wherein the control application is adapted to transmit a render command to a compositor.

34. The system of claim 30, wherein the event comprises a failure corresponding to one of the render nodes.

35. The system of claim 30, wherein the control application is adapted to determine a quantity of active nodes from the plurality of render nodes.

36. The system of claim 30, further comprising a compositor adapted to receive pixel data from at least a portion of the render nodes corresponding to a display portion assigned to each corresponding render node.
